(19) United States
(12) Patent Application Publication
(10) Pub. No.: US 2003/0099337 A1
(43) Pub. Date: May 29, 2003

(54) Method and apparatus for exchanging data between a primary computer system and an external computer system to ensure transactional reconciliation between the systems

(76) Inventor: H. Michael Lord, The Colony, TX (US)

Correspondence Address: R. ROSS VIGUET, FULBRIGHT & JAWORSKI L.L.P., 2200 ROSS AVENUE, SUITE 2800, DALLAS, TX, 75201-2784, US

(21) Appl. No.: 09/995,253

(22) Filed: Nov. 27, 2001

(51) Int. Cl. H04M 11/00

(52) U.S. Cl. 379/93.12

(57) ABSTRACT

A method of exchanging data between a primary system, such as a call processing system, and an external system to ensure transactional reconciliation between the systems, the method comprising the steps of creating a data message containing updated data within one of the systems, storing the data message within the system that created the data message, sending the data message to the other system, reading the data message within the other system, sending a receipt acknowledgment message to the system that sent the data message, and modifying data within either one or both of the systems according to the updated data contained within the data message.

### TECHNICAL FIELD

The invention relates to transactional computer systems, and more particularly to a method of exchanging data between a primary system and an external system to ensure transactional reconciliation between the systems.

### BACKGROUND OF THE INVENTION

Many transactional computer systems rely upon external computer systems for functionality, as well as database management associated with accounts relating to that functionality. For example, many premises-based telephone call processing systems, such as those found within correctional institutions, may be required to interact with other systems or databases to provide extended functionality of the call processing system. For example, a call processing system of a correctional facility may provide inmates access to a commissary system via one or more telephones, or terminals having DTMF input, in communication with the call processing system. Thus, the inmates can order commissary merchandise, such as candy, magazines, sundries, etc., via a telephone. The inmate typically pays for the merchandise through an account associated with one of the systems. The inmate is assigned a personal identification number (PIN) associated with the account so that the account can be debited in connection with a particular transaction. Thus, the process involves the exchange and maintenance of data associated with the commissary transactions as well as the inmate's account. Other functions offered through the call processing system may also involve the exchange and maintenance of data.

Data such as PIN information, account balance information, order information, and personal privilege information may need to be exchanged between the call processing system and an external system depending upon the application of the external system. As another example in connection with correctional facility applications, data relating to personal information or medical information for an inmate may be exchanged between the call processing system and the Law Enforcement Management System (LEMS), which includes the Jail Management System (JMS) and the Records Management System (RMS). Specifically, personal data such as image files of fingerprints or identifying marks, and medical data such as allergies or medications taken by the inmate, may be exchanged between the systems to update databases and keep the data current. Additional information relating to calls placed by a particular inmate, such as who the inmate calls, frequency of calls, etc., may also be collected by the call processing system and sent to the LEMS system to update the data relating to that inmate within the LEMS system. Virtually any type of data may be exchanged between the call processing system and other external systems.

A problem with data exchange between these systems, particularly with data exchanges relating to a transaction involving a credit or prepaid debit account, is the lack of consistency with respect to data updates. Many times a data message will be sent by one system to the other but never received by the other system. In such cases, the sending system will update its data according to a data change but the other system will not because it did not receive or verify the data message. Since data updates and messages are typically passed back and forth via text files, there is no reliable two-way audit trail to track and determine whether a file was sent or received. For example, if a text file is lost in transit due to a system outage, the records of the system sending the file may indicate that it sent the file but the other system will have no record of ever receiving the file. Furthermore, there is no reliable way for the system sending the file to verify receipt of the file by the other system. Thus, when reports are generated by the two systems, the reports are inconsistent due to these missed exchanges of data.

This inconsistency is extremely problematic when the data exchange is related to billing account transactions in connection with the functionality of one of the systems. When one system relies upon a data record of a particular transaction within the other system for accounting and inventory purposes, reconciliation between data within each of the systems becomes a problem when these data records are not received.

The present invention solves these and other problems associated with the exchange of data between systems.

### SUMMARY OF THE INVENTION

A method of exchanging data between a primary system, such as a call processing system, and an external system to ensure transactional reconciliation between the systems, the method comprising the steps of creating a data message containing updated data within one of the systems, storing the data message within the system that created the data message, sending the data message to the other system, reading the data message within the other system, sending a receipt acknowledgment message to the system that sent the data message, and modifying data within either one or both systems reflecting the updated data contained within the data message.

According to a further aspect of the invention, a method includes the steps of sending an initial request for data to the other system, and sending a response to the initial request for data to the system sending the initial request prior to the creation of the data message.

According to yet another aspect of the invention, a method is utilized to exchange data between a call processing system and an external system, wherein only the external system is deemed an official Database of Record for purposes of updating data and account reconciliation.

According to the invention, a method can be utilized to exchange any type of data between systems having independent software or hardware platforms. In specific applications, the method can be utilized to send a data message containing data relating to a telephone call placed on a telephone in communication with the call processing system, an order placed on a telephone in communication with the call processing system, or an account associated with a PIN number.

### BRIEF DESCRIPTION OF THE DRAWINGS

FIG. 1 is a block diagram depicting a generic implementation of the data exchange method of the invention between two computer systems.

FIG. 2 is a block diagram depicting the data exchange method of the invention implemented in a Microsoft Message Queue Server environment.

FIG. 3 is a flowchart of an example of a particular implementation of the data exchange method of the invention in connection with prepaid debit account related activity within a call processing system.

FIG. 4 is a flowchart of an example of a particular implementation of the data exchange method of the invention in connection with ordering commissary merchandise through a call processing system.

FIG. 5A is flowchart of an example of a particular implementation of the data exchange method of the invention in connection with a call processing system offering multiple feature functionality.

FIG. 5B is a flowchart of an example of an alternate feature depicted in the flowchart in FIG. 5A.

### DETAILED DESCRIPTION OF THE PREFERRED EMBODIMENTS

While the present invention will be described fully hereinafter with reference to the accompanying drawings, in which particular embodiments are shown, it is to be understood at the outset that persons skilled in the art may modify the invention herein described while still achieving the desired result of this invention. Accordingly, the description which follows is to be understood as an informative disclosure of specific embodiments under the invention directed to the understanding of persons skilled in the appropriate arts and not as limitations of the present invention.

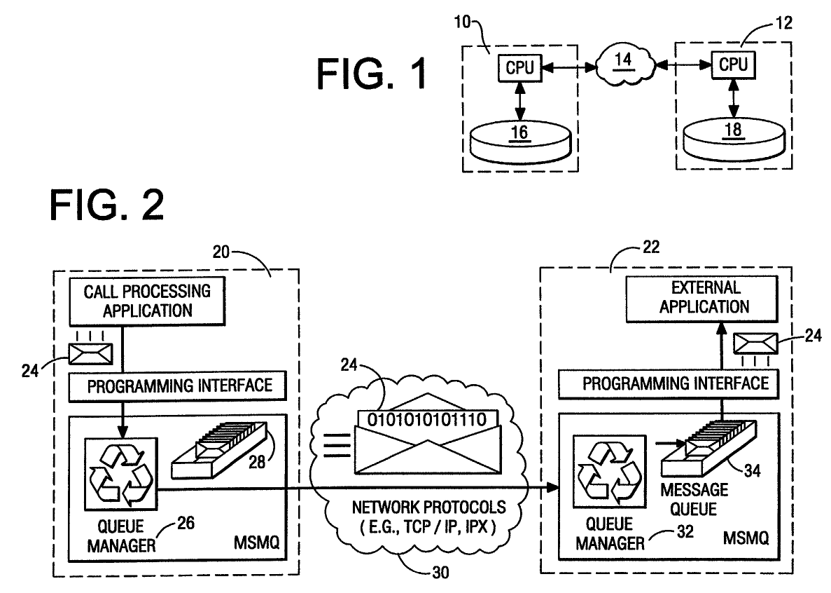

FIG. 1 and the following related discussion are intended to provide a brief general description of a suitable system environment in which a preferred embodiment of the invention may be implemented. FIG. 1 is a schematic disclosing a first system, or primary system 10, such as a call processing system, and a second system 12, which is an independent platform from the system 10 but is in communication therewith via a network 14. However, other embodiments of the invention can be implemented between different independent applications within the same system to ensure accurate data updates between the applications. As shown in FIG. 1, a database 16 is associated with the first system 10, and a database 18 is associated with the second system 12. When data changes within one of the systems 10 or 12 due to performance of a function or transaction, such as the processing a of telephone call, the changed data is communicated to the other system 10 or 12 so that the associated database 16 or 18 can be updated. In a preferred embodiment, the database 18 of the external second system 12 acts as a main database, or Database of Record, which stores a complete information record and updates main data tables, while the database 16 only stores data records of the specific data changes sent to the external second system 12. In this preferred arrangement, the Database of Record serves as the authoritative, or official, source of data relating to transactions between the systems. This arrangement greatly simplifies accounting for transactions. In a preferred embodiment, system 12 also stores the data record of the specific changes sent by the system 10, so that data within both systems can be reconciled if desired.

To ensure reconciliation between data within both systems 10 and 12, the invention implements a receipt acknowledgment message that is sent back to the system 10 or 12 that sent the data message containing the updated or changed data to the other system. In a particular embodiment, the data within the databases 16 or 18 will not be updated unless the receipt acknowledgment message is received by the system that originally sent the data message. In another embodiment, the database of the system that receives the data message is updated upon receipt of the data message. If the receipt acknowledgment message is never received by the sending system, then a record is kept of this fact. This can be done by storing the data message with added information indicating that a receipt acknowledgment message was not received. Thus, reconciliation between the two systems can be achieved with these records. In yet another embodiment, the data message can sit in a message queue (not shown) within the sending system until a receipt acknowledgment message is received. Thus, the message queue will provide an instantaneous record of the status between data exchanges between the systems.

In a preferred embodiment, one of the databases 16 or 18 will act as a Database of Record, which is the authoritative source of data and account information for both of the systems 10 and 12. In this embodiment, account information is only associated with the Database of Record. When accounts are audited, only the Database of Record need be reviewed. If needed, the other database may be checked with respect to particular transactional data.

In call processing system applications, the invention is implemented as a method of exchanging data between a call processing system and an external system to ensure reconciliation of data stored within each of the systems. The method comprises the steps of creating a data message containing updated data within one of the systems, storing the data message within the system that created the data message, sending the data message to the other system, reading the data message within the other system, sending a receipt acknowledgment message to the system that sent the data message, and modifying data within either one or both systems reflecting this activity. In a preferred embodiment, only the database of the external system acts as the Database of Record, i.e., the authoritative source of data and account information. In this preferred embodiment, account information, such as PIN number, account owner, etc., are only associated with the Database of Record and the database of the call processing system merely stores transactional data.

The invention is preferably implemented with “middleware” that coordinates communications and eliminates compatibility problems between independent systems.

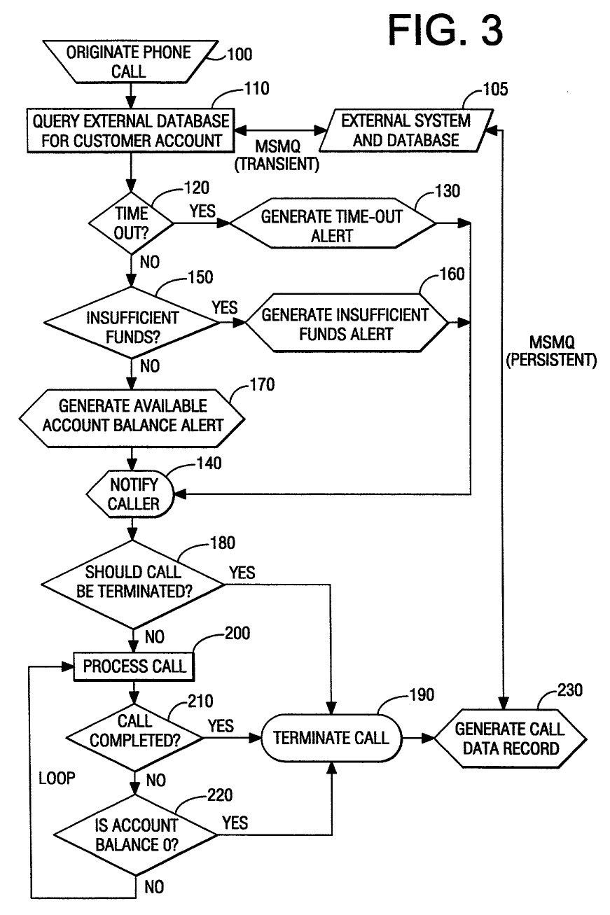

In a preferred embodiment, the invention is implemented through software such as Microsoft Message Queue Server (MSMQ). An example of this type of implementation is depicted by the block diagram shown in FIG. 2. However, before turning to a more detailed description of FIG. 2, a brief general description of MSMQ is believed to be helpful.

MSMQ implements asynchronous communications by enabling applications to send messages to, and receive messages from, independent applications. These applications may be running on the same machine or on separate machines connected by a network or telecom loop. MSMQ messages can contain data in any format that is understood by both the sender and the receiver. When an application receives a request message, it processes the request by reading the contents of the message and acting accordingly. If required, the receiving application can send a response message back to the original requester.

While in transit between senders and receivers, MSMQ keeps messages in memory locations called queues. MSMQ queues protect messages from being lost in transit and provide a place for receivers to look for messages when they are ready. This allows the sending and receiving systems to operate independently of each other in terms of timing. Applications make requests by sending messages to queues associated with the intended receiver. If senders expect responses in return, they must include the name of a response queue (that the sender must create in advance) in all requests that they make to the receiver. Two types of queues can be identified, a transient message queue and a persistent store-and-forward message queue. The transient message queue sends out messages but does not store the message and wait for a response to the message. On the other hand, the persistent store-and-forward message queue sends out the message and stores it until a response is received. The transient message queue is useful for requests that do not require confirmed delivery.

Turning now to FIG. 2, exchange of data between an institutional call processing system 20 and an external system 22 is implemented with MSMQ middleware. Although data can be exchanged in either direction, FIG. 2 depicts one direction for simplification. In FIG. 2, a data message 24 is created by the call processing system 20 and sent to a queue manager 26 that manages a message queue 28, which may include one or more transient message queues and persistent store-and-forward message queues. In a preferred embodiment, the message queue 28 includes an input and output persistent store-and-forward message queue and an input and output transient message queue. The data message may contain any type of information, such as a call detail record (CDR), commissary order information, prepaid debit account information, personal identification number (PIN) information, or the like. Initial data requests that are required to process a function associated with the call processing system 20, such as a request for an account balance associated with the functions of the external system 22, can be made to the independent external system 22 via the transient queue. However, since the data message 24 contains data that has been changed, such as in response to a performed function or a general data update, it must be sent to the external system 22 via the persistent store-and-forward message queue. This ensures that any data changes are captured by both systems.

The data message 24 is sent from the output persistent store-and-forward message queue of the call processing system 20 to the external system 22 over a network 30. Preferably, the network utilizes TCP/IP network protocol. Alternatively, the network may utilize IPX network protocol. When the data message 24 is received by the external system 22, a queue manager 32 of the external system 22 directs the message 24 to an input message queue of a message queue 34 of the external system 22. A receipt response (not shown) is sent back to the call processing system 20. The external system 22 applies the data message 24 within the external system 22, such as updating a database associated with the system or storing the data message 24 in a memory associated with the system. When the call processing system 20 receives the receipt response, the call processing system 20 appropriately applies the data message 24 within the call processing system 20. Thus, data is exchanged between the call processing system 20 and the external system 22, while insuring reconciliation between data within each of the systems.

It should be noted that the call processing system 20 is an independent system that offers functions not related to the external system 22. For example, the call processing system offers control and monitoring capabilities for telephone calls placed through the system. Likewise, the independent external system 22 offers functions not related to the traditional functionality of the call processing system 20. For example, the external system may be a commissary system for ordering goods and services via a telephone. By establishing reliable transactional data communication between the two systems, the external system 22 broadens the functional offerings of the call processing system 20 without the need to fully integrate the external functionality within the call processing system 20. In this way, both systems remain independent but benefit from the functionality of each other. It is important to note that each system maintains independent functionality such that it can execute certain functions without relying upon the other system.

It should also be noted that the invention can be implemented in numerous environments where reliable data exchange is desired. In some environments, only one system may have a database that stores data for both systems. In other environments, both systems have databases that each store certain data. In yet another environment, both systems have databases, but only one is designated the Database of Record. The information relating to data exchanges and related messaging can be stored within the systems in any number of ways and to any extent. Furthermore, it should be noted that the invention can be implemented in systems that do not support MSMQ. In such cases, a TCP/IP socket can be developed and implemented by one of ordinary skill in the art.

In a preferred embodiment, the data messages exchanged between the systems are written in a self-describing data format, such as XML format. XML is a standard mark-up language developed by the World Wide Web Consortium (W3C). Information regarding the XML standard is published and available to the skilled artisan. By utilizing a self-describing data format, the system receiving a data message can freely access the specific data it wishes to utilize without having to negotiate specific data fields with the system sending the data message. This gives the receiving system freedom to access any data it would like to utilize without the need for input from the sending system.

Merely by way of example, specific applications of the invention in connection with call processing systems of a correctional facility are discussed below.

### EXAMPLE 1

### Prepaid Debit Account Related Activity

In many correctional facilities, inmates can place telephone calls through the use of a prepaid debit account. In many instances, the prepaid debit account information is managed by an external service. Thus, account activity in connection with calls placed through the call processing system of the correctional facility must be reconciled with the independent external system.

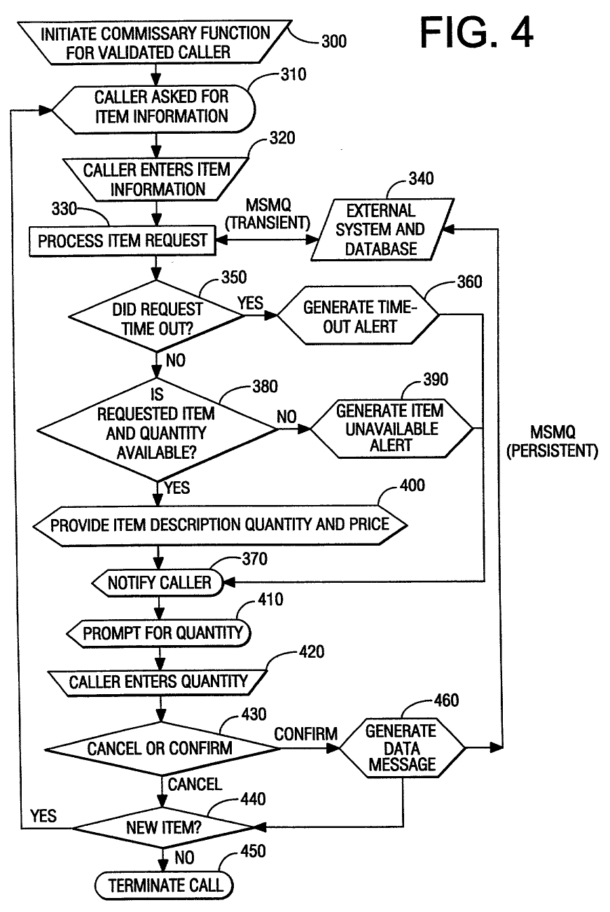

FIG. 3 shows a flow chart that helps illustrate a preferred implementation of this example. When an inmate initiates a telephone call at step 100, the call processing system requests account balance information associated with an inmate from an independent external system 105 via an MSMQ transient queue at step 110. The account can be associated with a particular inmate via a PIN number or various biometric techniques, such as finger print recognition, voice recognition, facial characteristic recognition, iris scan, or the like. If a response from the external system could not be obtained within a configurable timeout threshold at step 120, an alert is generated within the call processing system at step 130 indicating that a timeout has occurred. This can be done via SNMP and/or MAPI Send-Mail. The call processing system notifies the inmate that the prepaid debit platform is unavailable at step 140. If a response from the independent external system indicates that the inmate does not have sufficient funds available in the account at 150, the call processing system will generate an alert at step 160 and notify the inmate of this fact at step 140. If sufficient funds are available, the call processing system will generate an available account balance alert at step 170 and notify the inmate of the available account balance at step 140. If a timeout alert or an insufficient funds alert has been generated, the call may be terminated at steps 180 and 190. In a preferred embodiment, all notifications to the inmate are made by a WAV file that is played back to the inmate. Alternatively, text to speech technology can be utilized for all notifications. The use of TXT files would facilitate easier editing and downloading of such notifications.

If sufficient funds are available in the account, the call processor allows the call to be processed up to the amount of the account balance at steps 200, 210 and 220. When the call is completed at step 210 or when the account balance reaches zero at step 220, the call is terminated at step 190. The call processing system generates a call detail record (CDR) at step 230. The call processing system will pass a data message containing the CDR to the external system 105 via an MSMQ persistent store-and-forward message queue. The external system 105 reads the data message and applies relevant information from the CDR to one or more databases associated with the external system 105. A receipt message is then sent back to the MSMQ persistent store-and-forward message queue of the call processing system. The CDR may be stored by both systems to allow for future reconciliation between the call processing system and the external system.

### EXAMPLE 2

### Ordering Commissary Merchandise

Another function offered through correctional industry call processing systems is the ability for an inmate (caller) to order merchandise from an externally operated commissary system. This function allows an inmate to order merchandise via a telephone by entering item information, such as a SKU associated with a specific item.

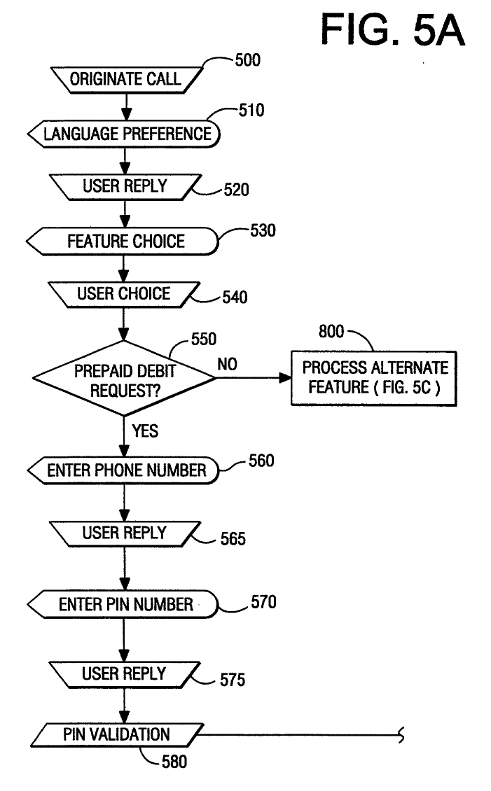

A preferred implementation of this function is illustrated by the flow chart in FIG. 4. After the commissary feature is initiated by a validated inmate within the call processing system at step 300, the inmate is prompted for item information at step 310. The inmate enters the item information, such as a SKU or other identifier, at step 320. At step 330, the call processing system will request item information for the specific SKU requested by the inmate from a database associated with an external commissary system 340 via an MSMQ transient message queue. If a response from the commissary system 340 cannot be obtained within a configurable timeout threshold at step 350, an alert is generated within the call processing system at step 360 indicating that a timeout has occurred. In a preferred embodiment, this can be done via SNMP and/or MAPI Send-Mail. In such a case, the call processing system will notify the inmate that the commissary system interface is unavailable at step 370. If a response indicates that the requested item is not available at step 380, the call processing system will generate an alert indicating that the item is not available at step 390 and notify the inmate that the item is unavailable at step 370. If a response indicates that the item is available, the call processing system obtains the item description and price from the response at step 400 and notifies the inmate of the item description and price at step 370. The call processing system prompts the inmate to enter a quantity to be ordered at step 410. The inmate enters a quantity at step 420 and is then prompted to confirm or cancel at step 430. If cancelled, the inmate is asked if a new item is to be ordered at step 440. If the inmate does not indicate that a new item is to be ordered, then the call is terminated at step 450. If confirmed, the item is ordered via a generated data message at step 460 and the inmate is asked if a new item is to be ordered at step 440. If the inmate does not indicate that a new item is to be ordered, the call is terminated at step 450. In this particular embodiment, a data message is sent to the external system after confirmation of each individual item ordered. In an alternative embodiment, all of the items entered by an inmate during a particular call may be added to a batch order and, upon termination of the call, a single data message containing the total order will be sent to the external system. Thus, only one data message would be sent per call. In a preferred embodiment, all notifications and prompts to the inmate are made by a WAV file that is played back to the inmate. Alternatively, text to speech technology can be utilized for all notifications. The use of TXT files would facilitate easier editing and downloading of such notifications.

When an item is ordered at step 460, the call processing system creates a data message containing the order information and passes the data message to the external commissary system 340 via an MSMQ persistent store-and-forward message queue. The external system 340 reads the data message and applies relevant order information from the data message to one or more databases associated with the external system 340. A receipt message is sent back to the MSMQ persistent store-and-forward message queue of the call processing system. The order information may stored by either one or both systems to allow for future reconciliation between the call processing system and the external system.

### EXAMPLE 3

### PIN Table Maintenance

The invention can also be used for passing data between systems for general database updating and management. In this particular example, PIN data is passed from an external system that maintains a database containing PIN data for inmates to the call processing system. The external system may be a commissary system, a general database management system, a prepaid debit account system, or the like.

This particular function can be utilized when data updates are required. When the PIN table maintenance function is initiated, an external system passes a data message containing the PIN information to the call processing system via an MSMQ persistent store-and-forward message queue. The call processing system reads the data message and applies relevant PIN information from the message to their database table(s). A receipt message is sent back to the MSMQ persistent store-and-forward message queue of the external system. The PIN information is stored by both systems to allow for future reconciliation between the call processing system and the external system.

### EXAMPLE 4

### Multiple Functionality

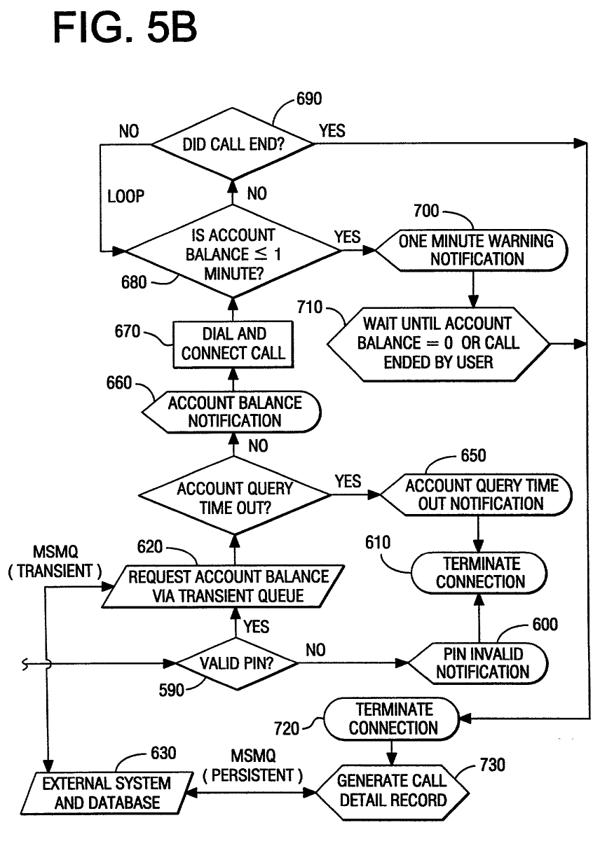

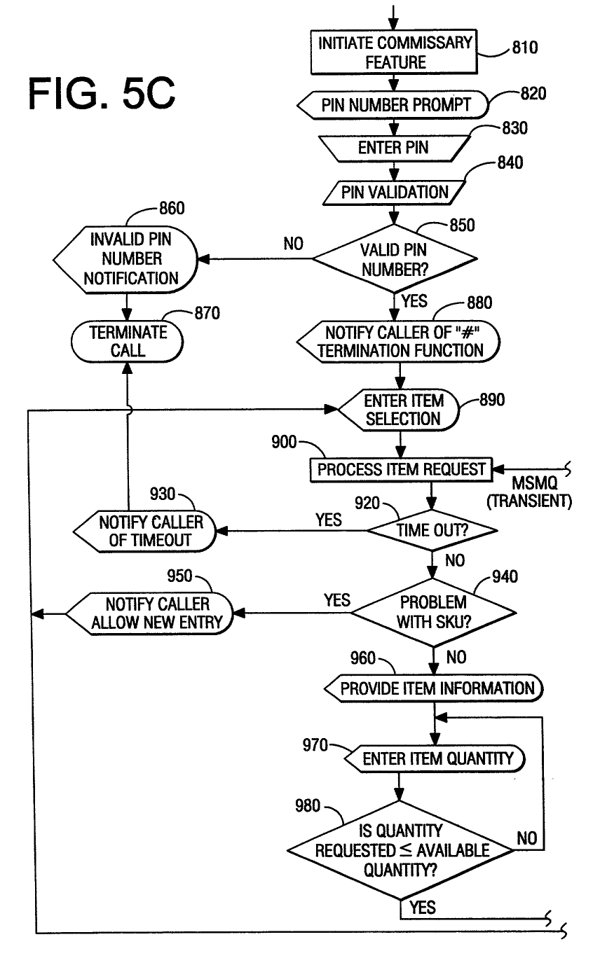

In a preferred embodiment, the call processing system offers multiple services and functions that utilize the invention. This embodiment is illustrated in the flow charts in FIGS. 5A and 5B. Referring to FIG. 5A, a user originates a call at step 500 by picking up a phone in communication with the call processing system. At step 510, the user is prompted in English to choose the language in which they want subsequent prompts to be spoken. At step 520, the user enters a language choice. The call processing system then prompts the user to choose among the features offered by the system at step 530, which may include, for example, prepaid debit phone calls or ordering from a commissary system. Based upon a feature selection entered at step 540, the particular feature is carried out by the call processing system and/or the external system and exchange of data between the systems is accomplished in accordance with the methods set forth herein. The internal functionality of both the call processing system and the external system can be carried out in a variety of ways that would be known to one of ordinary skill in the art of computer programming and database management. For simplicity, only the functionality of the call processing system side of the network will now be discussed in greater detail.

If the user choice is determined to be prepaid debit phone calls at step 550, the following process is executed within the call processing system. The call processing system prompts the user to enter a destination phone number at step 560. The user enters the number at step 565. The call processing system then prompts the user to enter their Personal Identification Number (PIN) at step 570. The user then enters their PIN at step 575. The call processing system verifies that the PIN entered is valid at step 580. If the PIN is determined to not be valid at step 590, the call processing system notifies the user that the PIN is not valid at step 600 and terminates the interaction with the user at step 610. If the PIN is valid, the call processing system sends an initial request for the account balance associated with that PIN to its transient output message queue at step 620, which is sent to an external system and database 630. If a response is not received in the transient input message queue of the call processing system within a configurable timeout threshold at step 640, the user is notified of this occurrence at step 650. If this occurs, the call processing system sends an alert message to every system on the network and terminates the interaction with the user at step 610. If a response is received in the transient input message queue, the call processing system notifies the user of the account balance amount at step 660. The call processing system then dials and connects the call at step 670. At steps 680 and 690, the call is processed until one minute of time can be satisfied by the account balance. The time threshold is configurable to any value. If this threshold is reached, the call processing system notifies the user at step 700 that only one minute (or other predetermined value) of conversation is left before the account balance is exhausted. At steps 710 and 720, the call processing system terminates the call when the balance in the account is exhausted or when the user terminates the call within the last minute. Upon termination of a call, the call processing system generates a Call Detail Record (CDR) and sends it to a persistent output message queue at step 730. The CDR includes the amount of the call. When the external system has completed its tasks associated with applying the amount of the call indicted in the CDR to the database, the call processing system then removes the CDR from its persistent input message queue.

If ordering from a commissary system is selected by a user at step 540 and determined by the call processing system at step 550, the following process is executed at step 800 in FIG. 5A. Step 800 is set forth in detail in FIG. 5B. Referring now to FIG. 5B, the call processing system initiates the commissary feature at step 810 and prompts the user to enter their Personal Identification Number (PIN) at step 820. The user enters their PIN at step 830. The call processing system verifies that the PIN entered is valid at step 840. If the PIN is determined to not be valid at step 850, the call processing system notifies the user that the PIN is not valid at step 860 and terminates interaction with the user at step 870. If the PIN is valid, the call processing system notifies the user at step 880 that entering the pound sign (#) at any subsequent prompt causes the termination of the interaction with the user. At step 890, the call processing system prompts the user to enter item information, such as a SKU for the item they want to purchase. The call processing system begins processing the request at step 900 and sends an initial request for information in connection with the selected SKU to its transient output message queue and sends the message to an external commissary system 910. If a response is not received in the transient input message queue of the call processing system within a configurable timeout threshold, the call processing system notifies the user of this occurrence as indicated at steps 920 and 930. If this occurs, the call processing system sends an alert message to every system on the network and terminates the interaction with the user at step 870. If the response indicates a problem with the selected SKU at step 940, the call processing system notifies the user of that fact at step 950 and repeats its processing to allow the entry of another SKU. If the response does not indicate any problems with the selected SKU, the call processing system notifies the user of the description, price and quantity available to purchase for the item associated with the selected SKU at step 960. The call processing system prompts the user to enter the quantity of the item associated with the selected SKU that they want to purchase at step 970. At step 980, the call processing system repeats the SKU and item information and re-prompts the user to enter the quantity if the user enters a quantity that exceeds the available quantity. If the quantity entered does not exceed the quantity available, the call processing system notifies the user of the SKU and quantity ordered at step 990 and prompts the user for verification at step 1000. If the user indicates that the order is not correct, the call processing system repeats its processing to allow the entry of another SKU by the user. If the order is correct at step 1010, the item order is placed in the persistent output message queue at step 1020 to be sent to the commissary system 910 and the user is notified that the order has been placed in the queue at step 1030. The call processing system then allows the entry of another SKU at 1040. If no further items are to be ordered, the call is then terminated at step 1050. When the commissary system 910 has completed its tasks associated with updating its database in connection with the item order based on the received data sent via the message queue, the call processing system then removes the order from its persistent input message queue.

In an alternative embodiment, all of the items entered by a user during a particular call may be added to a batch order and, upon termination of the call, a single data message containing the total order will be sent to the external system. Thus, only one data message would be sent per call.

It should be noted that the quantity limit feature of the previous example can be disabled by the commissary system to allow orders that exceed availability. This allows the commissary to make sales that rely upon replenishment shipments to complete the order.

### EXAMPLE 5

### Exchanges of Other Types of Data

As another example of data exchange in connection with correctional facility applications, data relating to personal information or medical information for an inmate may be exchanged between the call processing system and the Law Enforcement Management System (LEMS), which includes the Jail Management System (JMS) and the Records Management System (RMS). Specifically, personal data such as fingerprints or identifying marks, and medical data such as allergies or medications taken by the inmate, may be exchanged between the systems to update databases and keep the data current. Additional information relating to calls placed by a particular inmate, such as who the inmate calls, frequency of calls, etc., may also be collected by the call processing system and sent to the LEMS system to update the data relating to that inmate within the LEMS system. In addition to these types of data, virtually any type of data may be exchanged between the call processing system and other external systems in accordance with the methods of the invention.

### PIN Updates and CDR Acknowledgements

In a preferred embodiment, if a PIN update message is received in the persistent input message queue of the call processing system, the following process is executed. The call processing system copies the entire message to a PIN message history database. If the message indicates that the PIN is to be added, the call processing system updates its PIN database table by adding the PIN along with the first and last names of the user, whether the PIN is active or inactive and the current time. If the message indicates that the PIN is to be changed, the call processing system updates the record associated with the PIN. If the message indicates that the PIN is to be deleted, the call processing system removes the record associated with the PIN and copies it to a deleted PIN database. Regardless of the action indicated by the message, the call processing system sends an acknowledgment message to its persistent output message queue indicating receipt of the message. The call processing system then removes the PIN message from its persistent input message queue.

In a preferred embodiment, if a CDR acknowledgment message from the external system is received in the persistent input message queue of the call processing system, the following process is executed. The call processing system updates an acknowledged field in a record of a CDR database table within the call processing system. The table is keyed by the time of the start of the call, the destination phone number and the call processing system port identifier. The call processing system removes the CDR acknowledgment message from the persistent input message queue after the table is updated.

### Other Preferred Features

In a preferred embodiment, when an account is involved in a particular transaction, the invention incorporates a feature for locking out an account from being exhausted from multiple phones at the same time. This can be achieved through a software routine that could be created by one of ordinary skill in software programming.

In a preferred embodiment, communication between the call processing system and the external system is facilitated by four message queues for the call processing system, two of which are persistent store-and-forward message queues and two of which are transient message queues. One of each of the two types of queues are designated as an input and the other as an output. The specific application being utilized within the system provides the response queue property of the message if a response is expected. The MSMQ provides the time and date properties. All message content resides in the message body.

While the specific embodiments have been illustrated and described, numerous modifications may come to mind without significantly departing from the spirit of the invention, and the scope of protection is only limited by the scope of the accompanying claims.

What is claimed is:

1. A method of exchanging data between a call processing system and an external system to ensure reconciliation of data stored within each of the systems, the method comprising the steps of:
creating a data message containing updated data within one of the systems;
storing the data message within the system that created the data message;
sending the data message to the other system;
reading the data message within the other system;
sending a receipt acknowledgment message to the system that sent the data message; and
modifying data within either one or both of the systems according to the updated data contained within the data message.

2. The method of claim 1, wherein one of the systems is a Database of Record.

3. The method of claim 1, wherein the data message contains data written in a self-describing format.

4. The method of claim 1, wherein the data message contains data written in XML format.

5. The method of claim 1, wherein the data message contains data relating to a telephone call placed on a telephone in communication with the call processing system.

6. The method of claim 1, wherein the data message contains data relating to an order placed on a telephone in communication with the call processing system.

7. The method of claim 1, wherein the data message contains data relating to an account associated with a PIN number.

8. The method of claim 1, wherein the external system is a commissary system.

9. The method of claim 1, wherein the external system is the Law Enforcement Management System (LEMS).

10. The method of claim 1, further including the steps of:
sending an initial request for data to the other system; and
sending a response to the initial request for data to the system sending the initial request prior to the creation of the data message.

11. A method of exchanging data between a call processing system and an external system to ensure reconciliation of data stored within each of the systems, the method comprising the steps of:
creating a data message containing updated data within one of the systems;
sending the data message to the other system from a persistent store-and-forward message queue;
reading the data message within the other system;
sending a receipt acknowledgment message to the persistent message queue of the system that sent the data message; and
modifying data within either one or both of the systems according to the updated data contained within the data message.

12. The method of claim 11, wherein the data message contains data written in a self-describing format.

13. The method of claim 11, wherein the data message contains data written in XML format.

14. The method of claim 11, further including the step of:
removing the data message from the persistent store-and-forward message queue after data is modified within either one or both of the systems.

15. The method of claim 11, further including the step of:
saving the data message within either one or both of the systems to facilitate future reconciliation between both systems.

16. The method of claim 15, further including the step of:
sending an initial request for data to the other system from a transient message queue prior to creation of the data message.

17. The method of claim 16, further including the step of:
notifying a user of the call processing system if a response to the initial request for data is not received by the system that sent the initial request within a set amount of time.

18. The method of claim 16, further including the step of:
sending a response to the initial request for data to the system that sent the initial request prior to the creation of the data message.

19. A method for interfacing between a call processing system and an external system having a database containing information utilized by the call processing system, the method comprising the steps of:
selecting a desired function available via the call processing system;
requesting information relating to the selected function from the database of the external system;
sending the information to the call processing system;
evaluating the information to determine whether to allow the selected function to be performed;
performing the function within the call processing system;
storing data relating to the performed function within the call processing system;
sending the data to the external system; and
modifying the database of the external system based on the sent data.

20. The method of claim 19, wherein the database of the external system is the Database of Record.

21. The method of claim 19, wherein the data sent to the external system is in a self-describing format.

22. The method of claim 19, wherein the data sent to the external system is in XML format.

23. The method of claim 19, further including the step of:
sending a receipt acknowledgment message to the call processing system after the data is received by the external system.

24. The method of claim 19, further including the step of:
saving the data relating to the performed function within both of the systems.

25. A method of exchanging data between a call processing system and an external system in connection with prepaid debit related activity associated with a telephone call placed by a caller to ensure reconciliation of data stored within each of the systems, the method comprising the steps of:
identifying the caller;
sending an initial request for account balance information associated with the caller to a prepaid debit platform of the external system from a transient message queue of the call processing system;
notifying the caller that the prepaid debit platform is unavailable when a response from the external system is not received within a configurable time period;
notifying the caller that insufficient finds are available to complete the call when account balance information is received by the call processing system that indicates insufficient funds are available to complete the call;
notifying the caller of the account balance information when the account balance information is received by the call processing system that indicates sufficient funds are available to complete the call;
processing the call up to the account balance if sufficient funds are available to complete the call;
sending a call detail record (CDR) of the completed call to the external system from a persistent store-and-forward message queue of the call processing system;
modifying data within the external system according to the CDR when the CDR is received by the external system; and
storing the CDR within either one or both of the systems.

26. The method of claim 25, wherein the caller is notified by a WAV file message.

27. The method of claim 25, further including the step of:
generating an alert within the call processing system when a response from the external system is not received by the transient message queue within the configurable time period.

28. The method of claim 27, wherein the alert is generated via SNMP.

29. The method of claim 27, wherein the alert is generated via MAPI Send-Mail.

30. The method of claim 25, further including the step of:
preventing the account from being used by a second caller until data within the external system has been modified according to the data record of the completed call.

31. A method of exchanging data between a call processing system and an external commissary system in connection with ordering commissary merchandise via a telephone call placed by a caller to ensure reconciliation of data stored within each of the systems, the method comprising the steps of:
selecting an item by entering a SKU associated with the item via the telephone;
requesting item information for the SKU from the external commissary system via a transient message queue;
notifying the caller that the external commissary system is unavailable when a response from the external system is not received within a configurable time period;
notifying the caller that the item is not available when the item information for the SKU is received by the call processing system and indicates that the item is not available;
notifying the caller of the item description and price when the item information for the SKU is received by the call processing system and indicates that the item is available;
prompting the caller for an item quantity when the item is available;
sending an order for the item to the external commissary system from a persistent store-and-forward message queue of the call processing system;
reading the order within the external commissary system;
modifying a database associated with the external commissary system according to the order;
completing the order; and
storing data relating to the order within either one or both of the systems.

32. The method of claim 31, wherein the caller is notified by a WAV file message.

33. The method of claim 31, wherein the order contains data written in a self-describing format.

34. The method of claim 31, wherein the order contains data written in XML format.

35. The method of claim 31, further including the step of:
generating an alert within the call processing system when the response from the external commissary system is not received by the transient message queue within the configurable time period.

36. The method of claim 35, wherein the alert is generated via SNMP.

37. The method of claim 35, wherein the alert is generated via MAPI Send-Mail.

38. A method of exchanging data between a call processing system and an external system in connection with maintaining personal identification number (PIN) information associated with a caller to ensure reconciliation of data stored within each of the systems, the method comprising the steps of:
sending a PIN information message to the call processing system from a persistent store-and-forward message queue;
modifying a database within the external system according to the PIN information message when the PIN information message is received by the call processing system; and
storing the PIN information message within either one or both of the systems.

39. The method of claim 38, wherein the PIN information message contains data written in a self-describing format.

40. The method of claim 38, wherein the order contains data written in XML format.

41. A computer-readable medium having computer-executable instructions for performing steps for a server process to provide the exchange of data between a call processing system and an external system to ensure reconciliation of data stored within each of the systems, the steps comprising:
storing a data message created by and received from one of the systems that contains updated data;
sending the data message to the other system;
receiving a receipt acknowledgment message from the other system; and
removing the stored data message upon receiving the receipt acknowledgment;
wherein the other system modifies an associated database according to the updated data when the data message is read by the other system.

42. The computer-readable medium having computer-executable instructions for performing the steps of claim 41, wherein the system that sent the data message stores the data message as a record of the transaction.

43. The computer readable medium of claim 41, wherein the server process utilizes a persistent store-and-forward message queue for sending and receiving data messages.

44. The computer readable medium of claim 41, wherein the data message is a call detail record (CDR).

45. The computer readable medium of claim 41, wherein the data message contains information relating to an order for merchandise.

46. The computer readable medium of claim 41, wherein the data message contains information relating to a personal identification number (PIN).

47. The computer readable medium of claim 41, wherein the data message contains data written in a self-describing format.

48. The computer readable medium of claim 41, wherein the data message contains data written in XML format.

49. The computer readable medium of claim 41, wherein the external system is a commissary system.

50. The computer readable medium of claim 41, wherein the external system is the Law Enforcement Management System (LEMS).

51. A method of accounting for transactions occurring with a primary computer system that relies upon an external computer system for functionality, the method comprising the steps of:
selecting a desired function available to a user via the primary system;
requesting information relating to the selected function from a database of the external system;
sending the information to the primary system;
evaluating the information to determine whether to allow the selected function to be performed;
performing the function within the primary system;
sending data relating to the performed function to the external system; and
modifying the database of the external system based on the sent data.

52. The method of claim 51, further comprising the step of:
storing data relating to the performed function within the primary system prior to sending the data to the external system.

53. The method of claim 51, wherein the data is in a self-describing format.

54. The method of claim 51, wherein the data is in XML format.

55. A method of accounting for transactions occurring with a primary computer system that relies upon an external computer system to carry out the transaction, the method comprising the steps of:
creating a data message containing updated data within the primary system based on the transaction;
sending the data message to the external system from a persistent store-and-forward message queue;
reading the data message within the external system;
sending a receipt acknowledgment message to the persistent message queue of the primary system; and
modifying data within one of either and both of the systems according to the updated data contained within the data message.

56. The method of claim 55, wherein the data message contains data in a self-describing format.

57. The method of claim 55, wherein the data message contains data in XML format.

58. A call processor that relies upon an external computer system for selected functionality, the call processor comprising:
a computer-readable storage medium;
means recorded on the medium for facilitating selection of a desired function by a user through the call processor;
means recorded on the medium for requesting information relating to the selected function from a database of the external system;
means recorded on the medium for facilitating receipt of the requested information;
means recorded on the medium for evaluating the information to determine whether to allow the selected function to be performed;
means recorded on the medium for facilitating performance of the function through the call processor; and
means recorded on the medium for facilitating sending data relating to the performed function to the external system to allow the external system to update its data.

59. The computer readable medium of claim 58, wherein the data sent to the external system is in a self-describing format.

60. The computer readable medium of claim 58, wherein the data sent to the external system is in XML format.

61. The computer readable medium of claim 58, wherein the external system is a commissary system.

62. The computer readable medium of claim 58, wherein the external system is the Law Enforcement Management System (LEMS).

63. A call processing system that interacts with an external computer system to carry out a transaction within the call processing system, the call processing system including:
a computer-readable storage medium;
means recorded on the medium for facilitating the transaction within the call processing system;
means recorded on the medium for creating a data message containing updated data based on the transaction;
means recorded on the medium for sending the data message to the external system from a message queue;
means recorded on the medium for receiving a receipt acknowledgment message in the message queue; and
means recorded on the medium for removing the data message from the message queue upon receipt of the acknowledgment message.

64. The call processing system of claim 63, wherein the external system is the Database of record and the call processing system does not retain any record of the transaction.

65. The computer readable medium of claim 63, wherein the data message is in a self-describing format.

66. The computer readable medium of claim 63, wherein the data message is in XML format.

67. The computer readable medium of claim 63, wherein the external system is a commissary system.

68. The computer readable medium of claim 63, wherein the external system is the Law Enforcement Management System (LEMS).
